(19) United States
(12) Patent Application Publication
(10) Pub. No.: US 2004/0030721 A1
(43) Pub. Date: Feb. 12, 2004

(54) Device and method for data mirroring

(76) Inventors: Hans-Joachim Kruger, Aidlingen (DE); Georg Hodapp, Nurtingen-Raidwangen (DE); Jurgen Zipf, Bretten (DE)

Correspondence Address: BRUCE LONDA, NORRIS, MCLAUGHLIN & MARCUS, P.A., 220 EAST 42ND STREET, 30TH FLOOR, NEW YORK, NY, 10017, US

(21) Appl. No.: 10/399,204

(22) PCT Filed: Oct. 15, 2001
(86) PCT No.: PCT/EP01/11882

(30) Foreign Application Priority Data
Oct. 17, 2000 (DE) 100 53 016.8

(51) Int. Cl. G06F 17/00

(52) U.S. Cl. 707/104.1

(57) ABSTRACT

The invention relates to a device and a method for data mirroring, which can be used in particular for rapid data backup and reconstruction without losing any information. The method guarantees the reconstruction of the last error-free status of the original database present in a real time computer system. The method is characterised by a rapid switchover to a mirror computer system and as a result of its independence of the locations of the individual computer systems, it offers a high degree of protection against fire, floods, lightening strikes, vandalism and other disasters. In addition, the method has the following advantages: the transfer times are reduced by data compression and the security of the data is increased by an encrypted data transfer; structural modifications to the original database are also duplicated and any errors that occur are automatically identified and analysed. Measures for eliminating the errors are carried out on the basis of said identification and analysis.

The invention relates to a device and a method for data mirroring which can be used, in particular, for rapid data backup and data reconstruction without losing any information.

It is very important in information and computer technology to protect the often very large and complex data sets from being lost and damaged. Conventionally, various data backup methods are used which typically generate at certain time intervals a copy of the current database and archive this copy in an independent system. This copy is used in the event that the original database is corrupted to retain the functionality of the systems which access the data. These backup methods have the disadvantage that in the event of operator errors, hardware malfunctions, vandalism, fire and other catastrophic events, changes to the data made after the last backup copy cannot be reconstructed and are therefore lost.

Certain solutions which mirror databases synchronously can protect against data loss in the event of a hardware failure. Although the last actual data base remains intact, this method cannot be applied to logical errors, for example, if data are inadvertently deleted. These methods also leave the following problems unresolved: automatic adaptation of the mirror computer systems to changes of the database structure as well as automatic error recognition and switch-over to the mirror computer system. An additional disadvantage of the conventional solutions is that the programs have to be installed and controlled through scripts. These scripts have to be adapted to the environment of the existing systems which can be a rather complex task. This approach also has many inherent error sources. If data mirroring is carried out online using conventional processes, then larger databases may disadvantageously require long transmission times, and data security can be impaired due to the lack of encryption.

It is therefore an object of the invention to provide a device and a method for data mirroring, which eliminates the afore-mentioned disadvantages and guarantees in particular that the last error-free status of the original database that existed on the real-time computer system can be reconstructed without loss of data. The device and method of the invention should also be able to rapidly switch over to a mirror computer system, and to offer a high degree of protection from fire, flooding, lightning, vandalism and other catastrophic events, independent of the location of the individual computer systems. In addition, the proposed method should also shorten data transmission times and increase data security by compressing and encrypting the transmitted data, automatically detect structural changes in the original database and automatically recognize and analyze errors and automatically initiate measures to eliminate such errors.

This object is solved according to the invention by the characterizing features of claims 1, 2, 11 and 12 in conjunction with the features recited in the preamble.

Advantageous embodiment of the invention are recited in the dependent claims.

According to an advantageous aspect of the invention, the device includes at least two computer systems with storage devices and a program controllable by a timer, whereby the computer systems are connected with each other by data transmission means, and wherein a first computer system, the real-time computer system 2, contains the actual original database in a real-time data memory 3, and a second computer system, the mirror computer system 4, contains a previous version of this original database in an output data memory 5, and wherein the variable database, which contains all information about the actions performed on the real-time computer system 2, which have caused the real-time computer system 2 to change from the previous version to the actual status of the original database, is stored in an intermediate data memory 6 located on the storage media of the mirror computer system 4, and wherein the program is used to monitor the entire device and method and to control the automatic replacement of the real-time computer system 2 by the mirror computer system 4 based on pre-determinable criteria.

In certain situations, it may be advantageous that the device includes a computer system 2A with memory devices and a program controllable with a timer, wherein the actual original database is contained in a section of the memory device, the real-time data memory 3, and previous versions of the original database are contained in a section of the memory device independent thereof, the output memory 5, and that the variable database, which contains all information about the actions performed at the computer system 2A that have caused a change from the previous versions to the actual status of the original database, is stored in a third independent section of the memory device, the intermediate memory 6, and that the program is used to monitor the entire device and method and to control the automatic replacement of the original database by one of the previous versions based on pre-determinable criteria.

Data backup without data loss by reconstructing the last error-free status of an original database residing on a real-time computer system, as well as rapid replacement of a faulty real-time computer system by a mirror computer system and a high degree of protection from fire, flooding, lightning, vandalism and other catastrophic events can be ensured by placing the individual computer systems at separate locations, in particular by storing a copy of the database of a first real-time computer system 2 in a memory range, the output memory 5, of at least one second mirror computer system 4 that is independent of the real-time computer system 2, and by subsequently transmitting all information about changes of the real-time computer system 2 to the mirror computer system 4, where the information is intermediately stored and supplied to the output memory 5 under the control of a computer program with a settable temporal delay, if the status of the computer systems monitored by the computer program does not deviate from a defined status. Otherwise, a status of the real-time computer system 2 that is defined by pre-settable parameters is reconstructed with the help of the computer program from the data that exist in the output memory 5 of the mirror computer system 4 in conjunction with the variable database. Error-free status changes of the real-time computer system 2 are executed on the mirror computer system 4 by processing the variable database stored in the intermediate memory 6 of the mirror computer system 4.

If the risk of damage to the computer systems by vandalism and catastrophic events is low, then the data can be backed up by storing a copy of the original database contained in the real-time data memory 3 of the computer system 2A in a memory range of the computer system 2A, the output memory 5, which is independent of the real-time data memory 3, and by subsequently intermediately storing all information about changes of the original database, the variable data, in an additional independent memory range, the intermediate memory 6, and supplying this information to the output memory 5 under the control of a computer program with a settable time delay, if the status of the computer system 2A monitored by the computer program does not deviate from a defined status. Otherwise, a status of the original database defined by pre-settable parameters is reconstructed with the help of the computer program from the data existing in the output memory 5 in conjunction with the variable database by executing the error-free changes of the original database in the output memory 5 by processing the variable database stored in the intermediate memory 6.

The invention will now be described in more detail based on an embodiment depicted at least in part in the drawings.

It is shown in:

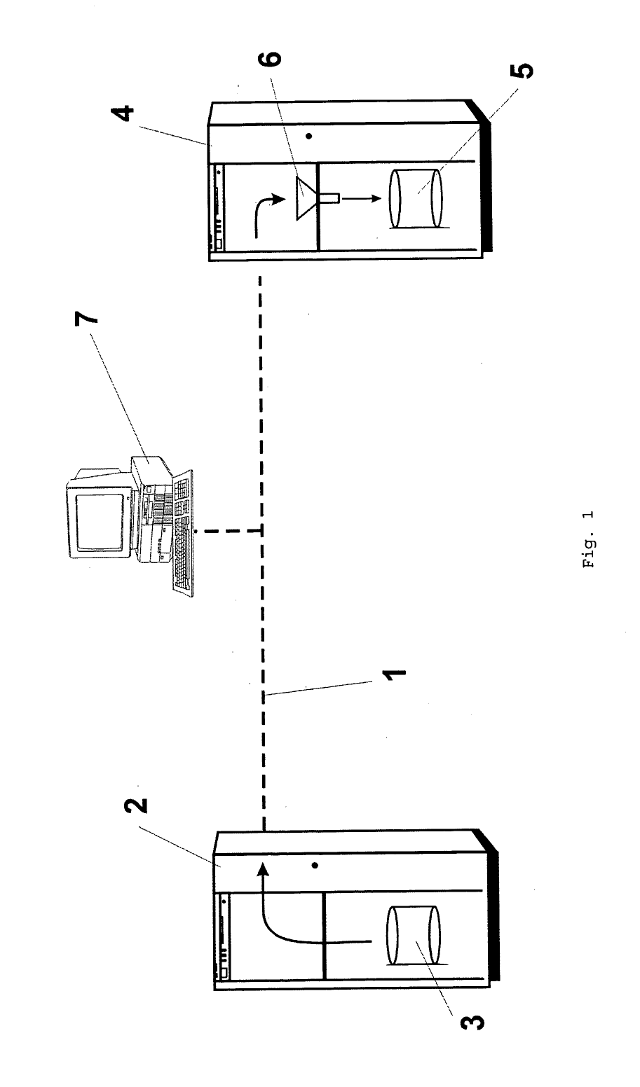

FIG. 1 a schematic diagram of a device with several computer systems and a graphic operating console;

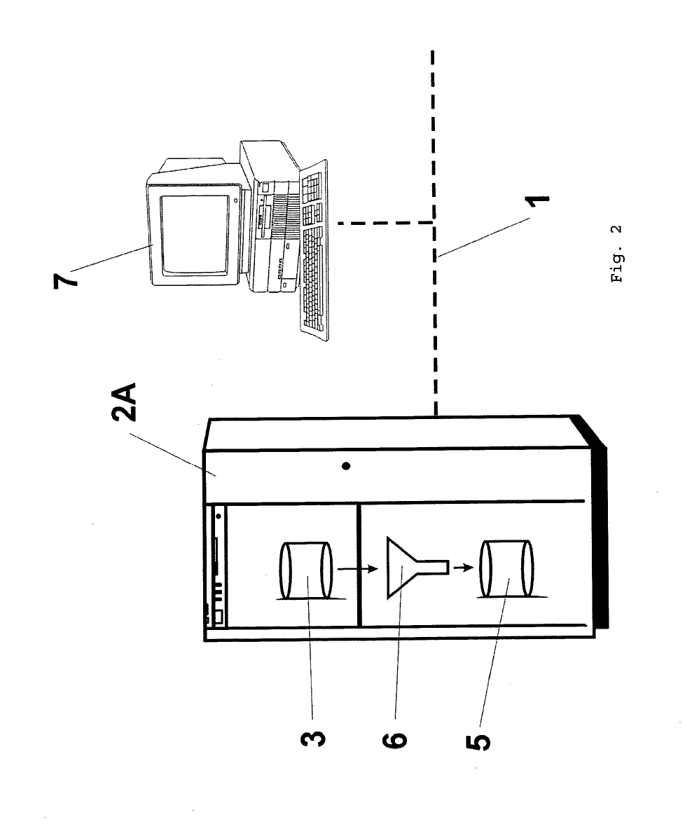

FIG. 2 a schematic diagram of a device implemented with a computer system and a graphic operating console;

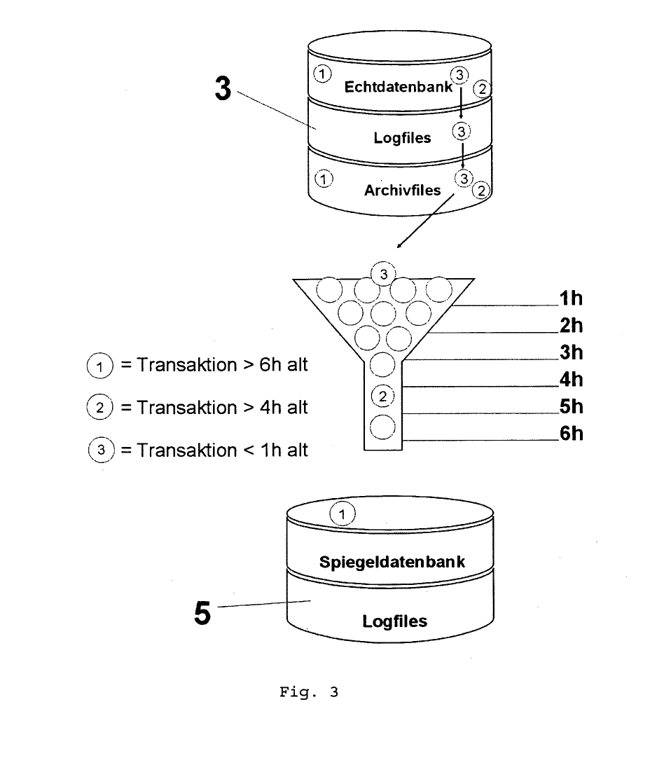

FIG. 3 the operating principle of the time delay (“time funnel”); and

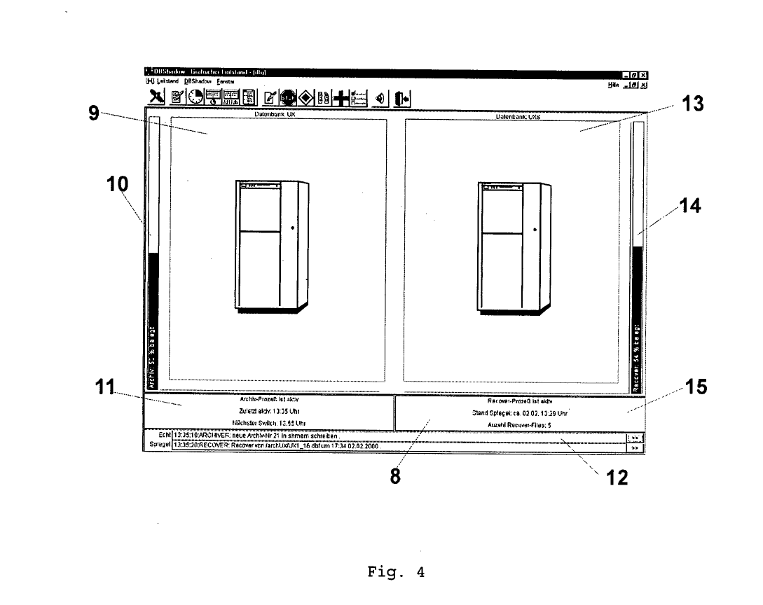

FIG. 4 an exemplary graphic user interface.

The method according to the invention makes it possible to mirror data residing on one or several systems in a network. The method is not directed to physical mirroring, but to logical mirroring. Device and method are simple to operate, offer maximum data security, rapid redeployment of the system after system failure and a low load on the transmission paths and the mirror computer systems.

The method for data mirroring is implemented with a computer program which is installed on the real-time computer system 2 and the deployed mirror computer systems 4. In addition, the status of the computer systems on which the method operates can be displayed and controlled on one (or also several) so-called graphic operating consoles 7. A graphic operating console 7 can be implemented as real-time computer system 2 as well as mirror computer systems 4, also as external devices, such as a radiotelephone. The graphic operating console 7 provides a comprehensible visualization of the actual status of the participating systems, which facilitates their operation and makes it unnecessary for system specialists to intervene in the execution of the process. This is particularly important in the event of a failure, since the switch-over to a functional system can be accomplished without having to rely on a small, special group of personnel. This also reduces downtime. The method is controlled automatically by several processes of the computer program which monitor the entire device and method, enable data communication between the graphic operating console 7 and the computer systems as well as between the various computer systems, monitor the real-time computer system 2, transmit the archived files to the mirror computer systems 4, reliably reconstruct the original database and bring the mirror database online. Shared memories and semaphores are used for communication and for synchronizing the processes. These processes monitor each other so that a process is automatically re-established after a failure.

After the installation from the graphic operating console 7, from an ASCII console or via a shell interface as a command line input has been completed and after the method for data mirroring is started, the original database of the real-time system 2 is copied to the mirror system 4 in a first step. This can be done even with a live system. Copying takes place via special (TCP/IP) socket programs which provide a fast and secure data communication. A separate port is used for this purpose. In addition, the method offers three options for data transmission during copying: sequential, parallel and compressed. The method also makes it possible to load the copy of the original database into the mirror systems 4 via external backup. The file systems and hard disk structures of the mirror computer systems 4 can be different from those of the real-time computer system 2. However, the same version of the operating system must be installed on all systems. The mirror system(s) 4 can be remote from the real-time system 2, with the limits defined by the size of the data communication network 1 in which the systems are embedded. This can provide optimal protection against catastrophic events (fire, lightning, flooding and the like). The method makes it also possible to mirror data even across continents. The method advantageously offers a more reliable data transfer of this type; special features of the method guarantee that the stricter requirements for data security are satisfied. The transmitted information can not only be encrypted, but the method also offers a high degree of data compression which reduces the transmission times by optimally using the bandwidth, in particular the bandwidth characteristic of long transmission lines. The method can advantageously be integrated with other monitoring programs or management software.

After the copy of the original database is stored on the mirror systems 4, all changes made in the real-time system 2 and documented in archive files are copied to the mirror systems 4, but are not yet executed. These changes are instead first supplied to a “time funnel” in which they remain for certain time before there are executed on the mirror system 4 and thereby supplied to the output data memory 5 (FIG. 3). This “time funnel” is the most important component of the device and method; it consists of a memory region—the intermediate memory 6—, which is typically installed on the hard disk of the participating mirror computer systems 4, and further of the archive files originating from the real-time computer system 2 and stored in the intermediate memory 6, as well as of a module of the computer program which is controlled by a timer and processes the archive files. The transmission of the archive files from the real-time system 2 to the mirror systems 4 is controlled by parameters that set the conditions under which a transmission takes place: this can be, for example, a time interval, after which the existing archive files are transmitted, or the archive files can be transmitted after reaching a certain size. It is also possible to change the parameters of the programs at any time by modifying the parameters via the graphic user interface 8 (FIG. 4) of the graphic operating console 7. Alternatively, shell interfaces can be used for this purpose. The residence time of the archive files in the intermediate memory 6 of the “time funnel” can be freely set over a wide range (from 0 minutes to several days) and independently for each mirror system 4. Moreover, different residence times for the archive files in the intermediate memory 6 can be defined for different time intervals. For example, under normal operating conditions, the residence time can be reduced during the work week, while it can be set to high value for the weekend. By executing all changes in the original database with a time delay, any erroneous action of the mirror system 4 can be easily prevented by stopping the mirroring process before the erroneous action leaves the “time funnel” and is executed. Since all preceding corrective changes have been made, the latest status of the real-time database is saved in the mirror database. If the program detects a faulty or erroneous action in the system, it sends a warning or an error message—for example, in combination with an acoustic signal—to the graphic operating console 7 or other programs with which the method is integrated, as described above. The faulty system is highlighted in color on the graphic user interface 8 of the graphic operating console 7, with the status of the message (warning, error, . . . ) being expressed in different colors. In addition, messages can be sent to external devices; for example via SMS or email to a radiotelephone, which can also be used to send commands to the computer program for controlling the method. The radiotelephone hereby assumes the function of a graphic operating console 7. If the system fails, a rapid switchover can be made to one of the mirror data bases and the operation can continue without any loss of data. The method detects if a failure was caused by a hardware error, or by an operating error or a software error. In the event of a hardware error in the real-time system, a switchover can be made automatically to the mirror system 4 without any loss of data. In the event of operating or software errors, the status the mirror database that should be backed up can be precisely determined. The actions in the “time funnel” are then executed up to the determined point in time, and the actual data are again available on the mirror system 4. After the cause of the error has been eliminated, the data residing on the mirror system 4 is copied back to the real-time system 2 and the normal operation is re-established.

The invention is not limited to the embodiments depicted herein. It is possible to realize additional embodiments by combining and modifying the aforedescribed means and features, without deviation from the scope of the invention.

List of Reference Numerals

1 data communication network

2 real-time computer system

2A computer system having real-time memory, intermediate memory and output data memory

3 real-time data memory

4 mirror computer system

5 output data memory

6 intermediate data memory

7 graphic operating console

8 graphic user interface

9 display of the real-time computer system

10 display of the memory use in the real-time computer system

11 display of the status of the real-time computer system

12 display of the actions executed last by the mirroring method

13 display of the mirror computer system

14 display of the memory use in the mirror computer system

15 display of the status of the mirror computer system

Figure Legend FIG. 3

Echtdatenbank Real-time database

Archivfiles Archive files

Transaktion >6h alt Transaction >6h old

Transaktion >4h alt Transaction >4h old

Transaktion >1h alt Transaction >1h old

Spiegeldatenbank Mirror database

1. Device for data mirroring, characterized in that
the device comprises at least two computer systems with storage devices and a program controllable by a timer, whereby the computer systems are connected with each other by data transmission means (1), and wherein a first computer system, the real-time computer system (2), contains the actual original database in a real-time data memory (3), and a second computer system, the mirror computer system (4), contains a previous version of this original database in an output data memory (5), and wherein the variable database, which contains all information about the actions performed on the real-time computer system (2), which have caused the real-time computer system (2) to change from the previous version to the actual status of the original database, is stored in an intermediate data memory (6) located on the storage media of the mirror computer system (4), and wherein the program is used to monitor the entire device and method and to control the automatic replacement of the real-time computer system (2) by the mirror computer system (4) based on pre-determinable criteria.

2. Device for data mirroring, characterized in that
the device comprises a computer system (2A) with memory devices and a program controllable with a timer, wherein the actual original database is contained in a section of the memory device, the real-time data memory (3), and previous versions of the original database are contained in a section of the memory device independent thereof, the output memory (5), and the variable database, which contains all information about the actions performed all the computer system (2A) that have caused a change from the previous versions to the actual status of the original database, is stored in a third independent section of the memory device, the intermediate memory (6), and the program is used to monitor the entire device and method and to control the automatic replacement of the original database by one of the previous versions based on pre-determinable criteria.

3. Device for data mirroring according to claim 1, characterized in that
additional mirror computer systems are implemented in addition to the first mirror computer system (4).

4. Device for data mirroring according to at least one of the claims 1 to 3, characterized in that
the method is controlled via a graphic user interface (8).

5. Device for data mirroring according to at least one of the claims 1 or 3 or 4, characterized in that
the graphic user interface (8) is provided on
the real-time computer system (2) and/or
the mirror computer system (4) and/or
a separate computer, the graphic operator console (7) and/or
a radiotelephone.

6. Device for data mirroring according to at least one of the claims 2 to 4, characterized in that
the graphic user interface (8) is provided on
the computer system (2A) and/or
a separate computer, the graphic operator console (7) and/or
a radiotelephone.

7. Device for data mirroring according to at least one of the claims 1 to 3, characterized in that
the intermediate memory is implemented as a First-In-First-Out (FIFO) memory.

8. Device for data mirroring according to at least one of the claims 1 to 7, characterized in that
the data transmission means are cable networks and/or wireless networks.

9. Device for data mirroring according to at least one of the claims 1 to 8, characterized in that
several data transmission means are provided for parallel data exchange.

10. Device for data mirroring according to at least one of the claims 1 or 3 to 8, characterized in that
the employed computer systems are configured differently with respect to their structure and/or device configuration.

11. Method for data mirroring, characterized in that
a copy of the database of a first real-time computer system (2) is stored in a memory range, the output memory (5), of at least one second mirror computer system (4) that is independent of the real-time computer system (2), and subsequently all information about changes of the real-time computer system (2) are transmitted to the mirror computer system (4), where the information is intermediately stored and supplied to the output memory (5) under the control of a computer program with a settable temporal delay, if the status of the computer systems monitored by the computer program does not deviate from a defined status, and otherwise a status of the real-time computer system (2) that is defined by pre-settable parameters is reconstructed with the help of the computer program from the data that exist in the output memory (5) of the mirror computer system (4) in conjunction with the variable database, in that the error-free status changes of the real-time computer system (2) are executed on the mirror computer system (4) by processing the variable database stored in the intermediate memory (6) of the mirror computer system (4).

12. Method for data mirroring, characterized in that
a copy of the original database contained in the real-time data memory (3) of the computer system (2A) is stored in a memory range of this computer system (2A), the output memory (5), which is independent of the real-time data memory (3), and subsequently all information about changes of the original database, the variable data, are intermediately stored in an additional independent memory range, the intermediate memory (6), and supplied to the output memory (5) under the control by a computer program with a settable time delay, if the status of the computer system (2A) monitored by the computer program does not deviate from a defined status, and otherwise a status of the original database defined by pre-settable parameters is reconstructed with the help of the computer program from the data existing in the output memory (5) in conjunction with the variable database, in that the error-free changes of the original database are executed in the output memory (5) by processing the variable database stored in the intermediate memory (6).

13. Method for data mirroring according to one of the claims 11 or 12, characterized in that
the data are transmitted in compressed and/or encoded form.

14. Method for data mirroring according to one of the claims 11 to 13, characterized in that
the data are transmitted in parallel over a plurality of data transmission pathways.

15. Method for data mirroring according to one of the claims 11 to 14, characterized in that
the data are transmitted
as determined by defined time intervals and/or
when the quantity of data to be transmitted reaches a certain size.

16. Method for data mirroring according to one of the claims 11 to 15, characterized in that
the method sends warnings, error messages or other information to other computer programs and/or to external systems.

17. Method for data mirroring according to one of the claims 11 to 16, characterized in that
the external system is a radiotelephone.

18. Method for data mirroring according to one of the claims 11 to 17, characterized in that
if the status of the real time computer system (2) deviates from a defined status, the data stored in the intermediate data storage (6) are transferred automatically according to predetermined rules into the output data memory (5), and the parameters of the computer program are automatically changed in such a way that as a result of this change one of the mirror computer systems (4) fully assumes the tasks of the original real-time computer system (2).

19. Method for data mirroring according to one of the claims 11 to 18, characterized in that
after the mirror computer system has been converted into the real-time computer system, the former real-time computer system is configured as a mirror computer system, i.e., the copy of the database of the current real-time computer system is stored in the output memory of the new mirror computer system, and all information about changes of the actual real-time computer system are subsequently transmitted to the new mirror computer system, where the information is intermediately stored and after a pre-settable temporal delay supplied under the control of the computer program to the output memory residing on the new mirror computer system.

20. Method for data mirroring according to one of the claims 11 to 19, characterized in that
the original database is copied into the output data memory (5) of the mirror computer systems (4) via the data transmission means.

21. Method for data mirroring according to one of the claims 11 to 19, characterized in that
the original database is copied into the output data memory (5) of the mirror computer systems (4) via an external backup.
